(19) United States
(12) Patent Application Publication
(10) Pub. No.: US 2009/0186121 A1
(43) Pub. Date: Jul. 23, 2009

(54) MODIFIED EDIBLE SUBSTRATES SUITABLE FOR PRINTING

(75) Inventors: Andrea Hutchison, St. Louis, MO (US); Karen Brimmer, St. Louis, MO (US); Penny Martin, St. Louis, MO (US); Gale Myers, St. Louis, MO (US); Scott Liniger, Maryville, IL (US)

Correspondence Address: MICHAEL BEST & FRIEDRICH LLP, 100 E WISCONSIN AVENUE, Suite 3300, MILWAUKEE, WI, 53202, US

(73) Assignee: SENSIENT COLORS INC., St. Louis, MO (US)

(21) Appl. No.: 12/299,146

(22) PCT Filed: May 1, 2007
(86) PCT No.: PCT/US07/67940

§ 371 Date: Oct. 31, 2008

Related U.S. Application Data
(60) Provisional application No. 60/796,393, filed on May 1, 2006.

(51) Int. Cl. A21D 13/08; A23G 4/18

(52) U.S. Cl. 426/5; 426/103; 426/293

(57) ABSTRACT

An edible substrate treated with an edible substrate enhancer and printed with an image. Methods for treating edible substrates with an edible substrate enhancer, and for printing an image onto the treated edible substrate are provided.

### CROSS-REFERENCE TO RELATED APPLICATIONS

This application claims benefit of priority to U.S. Provisional Application Ser. No. 60/796,393, filed May 1, 2006, incorporated herein by reference in its entirety.

### BACKGROUND OF THE INVENTION

A variety of inks comprising colorants may be printed onto a variety of edible substrates to produce a printed image. However, depending on the edible substrate and the conditions, the printed image may blur, smear or bleed resulting in a fuzzy appearance. The invention provides an edible substrate enhancer that reduces the blurring, smearing or bleeding of an image printed onto an edible substrate.

### SUMMARY OF THE INVENTION

In one aspect, the invention provides an edible substrate having a portion of its surface coated with edible substrate enhancer granules. The edible substrate enhancer may be a cellulose derivative, a silica, a dextrin, or a combination thereof. An image is printed on the portion of the surface coated with the edible substrate enhancer surface. The edible substrate enhancer is present in an amount that reduces moisture at the surface and improves the quality of the image printed on the portion of the surface.

In another aspect, the invention provides a method of printing an image onto the surface of an edible substrate. A portion of the surface is treated a composition comprising an edible substrate enhancer and less than about 10% water by weight and an image is printed onto the treated surface. The edible substrate enhancer is present in an amount that improves the quality of the image printed on the surface.

In another aspect, the invention provides a method for ink jet printing an image onto an edible substrate having a surface. At least a portion of the surface of the edible substrate is treated with a composition comprising less than about 5% water by weight and an edible substrate enhancer. The edible substrate enhancer may be a cellulose derivative, a silica, a dextrin, or a combination thereof. An image may be ink jet printed on the treated surface. The edible substrate enhancer is present in an amount that improves the quality of the image printed on the surface.

### DETAILED DESCRIPTION OF THE INVENTION

Before any embodiments of the invention are described in detail, it is to be understood that the invention is not limited in its application to the details of construction and the arrangement of components set forth in the following description. The invention is capable of other embodiments and of being practiced or of being carried out in various ways. Also it is to be understood that the phraseology and terminology used herein is for the purpose of description and should not be regarded as limiting. The use of “including,” “comprising,” or “having” and variations thereof herein is meant to encompass the items listed thereafter and equivalents thereof, as well as additional items. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any nonclaimed element as essential to the practice of the invention.

A wide variety of edible substrates may be manipulated with topical edible substrate enhancers to make them more susceptible to printing. As used herein, “edible substrate” or “substrate” includes any material suitable for consumption, such as a food product, that is capable of being treated with an edible substrate enhancer, and having an image disposed thereon. Examples of edible substrates that may be suitable for an edible substrate enhancer include snack chips (e.g., sliced potato chips), fabricated snacks (e.g., fabricated chips such as tortilla chips, potato chips, potato crisps, taco shells), extruded snacks (e.g. marshmallow-based treats), cookies, cakes (including snack cakes), chewing gum, candy, various bread products (e.g., biscuits, toast, buns, bagels, and tortillas), fruit, dried fruit, granola bars, rice cakes, chocolates, candies, breakfast bars, crackers, waffles, mints, fruit roll ups, beef jerky, crackers, pasta, hot dogs, sliced meats, cheese, pancakes, waffles, dried fruit film, breakfast cereals, toaster pastries, ice cream cones, ice cream, gelatin, ice cream sandwiches, ice pops, icings, yogurt, desserts, cheese cake, pies, pie crusts, cup cakes, English muffins, pizza, meat patties, and fish sticks. Although the above substrates are typically associated with human consumption, it should be understood that any substrate fit for human or animal consumption may be used. Additional examples may include pet treats, such as dog bones, dog and cat snacks, and dog biscuits.

As used herein, an “edible substrate enhancer” includes any material that can be added or applied to an edible substrate to improve the receptivity of the edible substrate to a printed image. As used herein, an improvement in the “receptivity” of a surface of an edible substance to a printed image means a reduction in at least one of blurring, smearing or bleeding of a printed image. Specifically, images printed onto edible substrates to which the edible substrate enhancer has been added may have reduced blurring, smearing or bleeding compared to a printed image on a substrate to which the edible substrate enhancer has not been added.

Suitably, the edible substrate enhancers are food grade materials. Suitable edible substrate enhancers include, but are not limited to, monosaccharides (such as glucose and fructose), disaccharides (such as sucrose and lactose), polysaccharides (such as pectins, starches, and starch derivatives (e.g. maltodextrins, dextrins, cyclodextrins, modified starches such as corn, potato, and tapioca starches)), cellulose derivatives (such as microcrystalline cellulose, carboxymethylcellulose, hydroxypropylcellulose, methylcellulose, hydroxypropylmethyl-cellulose (HPMC), Karaya, ghatti), gums (such as guar gums, locust bean gums, gum Arabic, tragacanth, agar, carrageenan, alginates, dextrans, xanthan and gellan), proteins (such as glutens, including whey, gelatins, and amino acids) or minerals and their salts (such as aluminum sulfate, potassium aluminum sulfate, calcium carbonate, calcium lactate, magnesium hydroxide, magnesium oxide, sodium chloride, silicon dioxide, calcium silicate, and phosphates). A combination of two or more suitable edible substrate enhancers may also be used to treat the edible substrate.

Suitable edible substrates may be moist at the surface. Moisture at the surface of an edible substrate may be an inherent feature of the composition of the substrate, or may result from heating or baking the edible substrate. Often, as an edible substrate cools after heating, the moisture evaporates from the surface, thereby drying the surface of the edible substrate. The edible substrate enhancer of the invention may absorb or adsorb the excess moisture from the edible substrate, or may otherwise effect a loss of moisture from the surface. For example, the edible substrate enhancer may increase the rate at which moisture evaporates from the surface of the edible substrate. The edible substrate enhancer may thereby facilitate printing onto an edible substrate that is still warm from heating or baking, without requiring that the edible substrate be first cooled. This feature is particularly advantageous when heated edible substrates are produced on an assembly line. Suitably, the edible substrate may have an average temperature of at least about 30° C., at least about 35° C., at least about 40° C., at least about 45° C., at least about 50° C., at least about 55° C., at least about 60° C., at least about 65° C., at least about 70° C., at least about 80° C., or at least about 90° C. when the image is printed onto the surface comprising the edible substrate enhancer.

As used herein, the phrase “food grade” means that up to specified amounts of the particular compound can be ingested by a human without generally causing deleterious health effects. Examples of food grade compounds include those compounds “generally recognized as safe” (“GRAS”) by the United States Food and Drug Administration (“FDA”) and colorants approved by the FDA for use in foods for human consumption. In particular, food safe compounds include those compounds listed as approved under 21 C.F.R. §§ 73, 74, 172, 182 and 184.

As used herein, “treating” or “treatment,” refers to contacting or contact of the edible substrate with an effective amount of an edible substrate enhancer. Treatment may be accomplished by topical application directly or indirectly onto the edible substrate or by combining the edible substrate enhancer with one or more components of the edible substrate. The addition of the edible substrate enhancer to the edible substrate may be accomplished by any process that is compatible with the invention. The addition of the edible substrate enhancer can also be tailored to a specific edible substrate. For example, if the edible substrate includes a dry ingredient suitable as a carrier for the edible substrate enhancer, the edible substrate enhancer can be added to that dry ingredient. For topical applications, the edible substrate enhancer suitably may be directly added, delivered or dispersed onto the surface of the edible substrate, by scattering, coating (including film-coating), dipping, pouring, spraying, misting, or brushing. Topical treatment of the edible substrate may be facilitated using a liquid or gas propellant. If the edible substrate is frosted or iced, the edible substrate enhancer may be included in the frosting or icing. The edible substrate enhancer of the invention may be manipulated to affect moisture retention and/or loss from the surface of an edible substrate and thereby influence the quality of the image printed on the edible substrate.

As used herein, a “treated edible substrate” refers to an edible substrate, that has been treated with at least an edible substrate enhancer. Suitably, the edible substrate enhancer may be in the form of granules when contacted with the edible substrate. A “granule,” as used herein, refers to a particle being at least about 0.5 microns in average diameter. Suitably, the edible substrate enhancer may be in the form of particles having a average diameter of at least about 0.05 microns, at least about 0.1 microns, at least about 0.2 microns, at least about 0.3 microns, at least about 0.4 microns, at least about 0.6 microns, at least about 0.7 microns, at least about 0.8 microns, at least about 1 micron, at least about 1.5 microns, or at least about 2 microns. Suitably, the edible substrate may be contacted with the edible substrate enhancer granules by, for example, shaking or pouring the granules onto the edible substrate. Suitably, if the edible substrate enhancer granules are mixed with a carrier prior to being contacted with the edible substrate, the carrier may itself comprise granules, or the carrier may be a liquid and be combined with the edible substrate enhancer to form a slurry or suspension. Suitably, the granules of the edible substrate enhancer do not cover the surface of the edible substrate in a substantially continuous and uniform layer, for example, as would occur if a solution of the edible substrate enhancer was applied to the edible substrate, and the solvent was dried or allowed to evaporate. Rather, the granules of the edible substrate enhancer on the edible substrate may suitably form an incomplete layer randomly or non-randomly distributed on the surface of the edible substrate.

As used herein, a “carrier” includes any material that is compatible with the edible substrate, that facilitates treatment of the edible substrate with the edible substrate enhancer, and that does not increase the water content of the edible substrate. Examples of carriers include, but are not limited to, solvents (e.g. alcohols), liquids or fluids and dry carriers (e.g. sugars, such as sucrose, glucose, fructose and maltose, sugar substitutes such as sorbitol, xylitol, malitol, mannitol, Isomalt, sucralose, saccharin, aspartame, neotame and acesulfame potassium, starches or flours, dextrins and dextrans). Optionally, an edible substrate enhancer may be combined with a carrier to facilitate the delivery of the edible substrate enhancer over the surface of the edible substrate, or to facilitate distribution of the edible substrate enhancer in the edible substrate. For example, the edible substrate enhancer may be dissolved into a solvent, or dispersed into a liquid or fluid and sprayed onto the surface of the edible substrate. The edible substrate enhancer may also be combined with a dry carrier, such as a powdered, crushed, ground, crystallized or particulate carrier to facilitate dispersion onto the edible substrate. Sugar carriers may suitably be finely powdered or crystallized. The carrier may dilute the edible substrate enhancer and facilitate even dispersion over the surface of, or within, the edible substrate. A combination of two or more suitable carriers may also be used to treat the edible substrate.

Suitably, the edible substrate enhancer, carrier, or combination of edible substrate enhancer and carrier comprises by weight less than about 12% water, less than about 10% water, less than about 8% water, less than about 5% water, less than about 4% water, less than about 3% water, less than about 2% water, less than about 1% water, less than about 0.5% water, less than about 0.25% water, or less than about 0.1% water.

Suitably, the ratio of carrier to edible substrate enhancer may be at least about 0.2:1, at least about 0.5:1, at least about 1:1, at least about 2:1, at least about 3:1, at least about 5:1, at least about 9:1, at least about 19:1, at least about 49:1 or at least about 99:1. Suitably, the ratio of carrier to edible substrate enhancer may be between about 0.2:1 and about 100:1, particularly between about 1:1 and about 99:1, and more particularly between about 9:1 and about 99:1.

Suitably, the edible substrate enhancer may be applied to cover from at least about 0.01%, particularly at least about 0.05% and more particularly at least about 0.1% and from less than about 5%, particularly less than about 3%, and more particularly less than about 1% of the surface of the edible substrate.

Once the edible substrate has been treated with the edible substrate enhancer, an image may be printed directly or indirectly onto the edible substrate using any printing technique known in the art. Printing disperses a food grade colored fluid onto the surface of the edible substrate to form an image. Suitable printing techniques include, but are not limited to, gravure, ink jet, thermal ink jet, drop on demand, or valve jet. Suitable printing techniques are described, for example, in U.S. Pat. No. 7,029,112, the disclosure of which is hereby fully incorporated by reference. A satisfactory image may be obtained using piezo ink jet printing. Examples of manufacturers from which the print heads may be obtained include SPECTRA®, XAAR®, HITATCHI® and PICOJET®. As used herein, a “colored fluid” is a solution, suspension, dispersion or colloid that includes a colored material, such as a dye or pigment. An example of a colored fluid is an ink.

Suitably, the edible substrate enhancer is applied to the surface in an amount effective to improve the quality of an image printed onto the edible substrate compared with an image printed as the same substrate without an edible substrate enhancer. Suitably, the edible substrate enhancer is applied to the surface of the edible substrate in an amount of at least about 0.01 mg/cm² surface, at least about 0.02 mg/cm² surface, at least about 0.03 mg/cm² surface, at least about 0.05 mg/cm² surface, at least about 0.1 mg/cm² surface, at least about 0.25 mg/cm² surface, at least about 0.5 mg/cm² surface, at least about 0.75 mg/cm² surface, at least about 1 mg/cm² surface, or at least about 3 mg/cm² surface. Suitably, the edible substrate enhancer is applied to the surface of the edible substrate at less than about 200 mg/cm² surface, less than about 100 mg/cm² surface, less than about 75 mg/cm² surface, less than about 50 mg/cm² surface, less than about 25 mg/cm² surface, less than about 20 mg/cm² surface, less than about 15 mg/cm² surface, less than about 10 mg/cm² surface, or less than about 6 mg/cm² surface. When the edible substrate enhancer is combined with a carrier, suitably, the combination of edible substrate enhancer and carrier is applied to the surface of the edible substrate in an amount of at least about 0.5 mg/cm² surface, at least about 1 mg/cm² surface, at least about 2 mg/cm² surface, at least about 3 mg/cm² surface, at least about 5 mg/cm² surface, at least about 10 mg/cm² surface, at least about 25 mg/cm² surface, at least about 50 mg/cm² surface, at least about 75 mg/cm² surface, at least about 100 mg/cm² surface, or at least about 200 mg/cm² surface. Suitably, the combination of edible substrate enhancer and carrier is applied to the surface of the edible substrate at less than about 1000 mg/cm² surface, less than about 750 mg/cm² surface, less than about 500 mg/cm² surface, less than about 400 mg/cm² surface, less than about 300 mg/cm² surface, or less than about 250 mg/cm² surface. Excess edible substrate enhancer, or edible substrate enhancer combined with a carrier may suitably be removed either before or after the image is printed, for example, by shaking, brushing or blowing the surface. Any removed edible substrate enhancer, or edible substrate enhancer combined with a carrier, may be suitably reused and applied to a different surface of the edible substrate or to a different edible substrate.

In one embodiment, the edible substrate enhancer does not form a complete continuous or smooth coating or layer, such as would form if a solution of the edible substrate enhancer were applied to the edible substrate. Suitably, the layer of edible substrate enhancer covers at least about 75%, at least about 80%, at least about 85%, at least about 90%, at least about 95%, at least about 97%, at least about 98%, at least about 99%, or at least about 99.5% of the surface of the edible substrate where the image is printed. Suitably, the layer formed by the edible substrate enhancer where the image is to be printed has randomly distributed variations in depth of at least about 0.05 microns, at least about 0.1 microns, at least about 0.15 microns, at least about 0.2 microns, at least about 0.25 microns, at least about 0.3 microns, at least about 0.4 microns, or at least about 0.5 microns.

Suitably the edible substrate enhancer may be incorporated into a frosting or icing that is applied to the edible substrate. The edible substrate enhancer may comprise at least about 0.01%, at least about 0.05%, at least about 0.1%, at least about 0.2%, at least about 0.3%, at least about 0.5%, at least about 0.75%, at least about 1%, or at least about 3% by weight of the frosting or icing.

The food grade colored fluids that may be printed onto the treated edible substrate of the invention may comprise food grade dyes or pigments, glycols, such as polypropylene glycols, and other optional components such as water, glycerine, lower alcohols and/or shellac. The food grade colored fluids may have a low water content, or may be free of or substantially free of water. For example, the colored fluid may contain one or more of at least about 1% glycerine, at least about 10% propylene glycol, at least about 5% alcohol, less than about 15% water, at least about 1% shellac or combinations thereof. Inks suitable for printing onto the treated edible substrate are described, for example, in U.S. Pat. No. 7,029,112, and in U.S. Application Publication Nos. 20040086603, 20040175463, 20050003055, 20050003056, 20050069612, 20050255205, and 20060034984, the disclosures of each of which are hereby fully incorporated by reference, and in particular disclosure regarding inks suitable for printing on edible substrates. The food-grade colored fluids have characteristics that render them suitable for printing directly onto the surfaces of a variety of edible substrates. In particular, the food grade colored fluids may be suitable for printing with ink jet printers, including piezoelectric ink jet printers.

Suitable food grade dyes used in the colored fluids may include synthetic dyes, natural dyes, or combinations thereof. As used herein, the term “dye” denotes dyes which are soluble in water and/or in the other cosolvents, which contain substantial amounts of glycols and/or glycerine, of the colored fluid. In some embodiments, the colored fluids may be substantially free of insoluble materials. Suitable synthetic dyes for use in the present coloring fluids include food grade FD&C dyes, such as FD&C Red #3, FD&C Red #40, FD&C Yellow #5, FD&C Yellow #6, FD&C Blue #1, and FD&C Green #3. Suitable natural dyes include, but are not limited to, turmeric oleoresins, cochineal extracts, gardenia extracts, and natural colors derived from vegetable juices. Other specific examples of suitable natural dyes include, but are not limited to, beet extract, grape skin extract, and chlorophyll containing extracts (e.g. nettle extract, alfalfa extract and spinach extract). To achieve a desired color tint or shade, the colored liquids may include mixtures of more than one synthetic and/or natural food grade dye.

Suitable food grade pigments used in the colored fluids may include, but are not limited to, lakes made with FD&C dyes (e.g., FD&C Blue #1, FD&C Blue #2, FD&C Green #3, FD&C Red #2, FD&C Red #3, FD&C Red #40, FD&C Yellow #5, and FD&C Yellow #6).

Suitably the improvement in image quality when an image is printed onto the surface of an edible substrate comprising the edible substrate enhancer, compared with images printed onto the same edible substrate without the edible substrate enhancer, may include a reduction in at least one of a bleed, wicking or raggedness of the colored fluid used to create the image. Wick and bleed are evaluated by measuring the characteristics of a printed line with a known thickness (for example, 280 μm). Wick is a measurement of this line on paper. Bleed is a measurement of this line contained within a box of the other colors. Raggedness is a measure of the geometric distortion of an edge of the line from its ideal position. For example, bleeding or wicking of the colored fluid of the image may be reduced by at least about 5 microns, at least about 10 microns, at least about 15 microns, at least about 20 microns, at least about 25 microns, or about at least 30 microns. Images printed on an edible substrate comprising an edible substrate enhancer may reduce the raggedness of a line printed onto the coated surface, by at least about 2 microns, at least about 5 microns, at least about 10 microns, at least about 15 microns, at least about 20 microns, or at least about 25 microns, compared with images printed onto the same edible substrate without the edible substrate enhancer.

In the following examples all percentage amounts are percentages by weight, unless indicated otherwise.

### EXAMPLE 1

### Treatment of Marshmallow Treats with a Variety of Edible Substrate Enhancers and Assessment of Image Printed onto Treated Marshmallows

Marshmallow treats were treated with a variety of edible substrate enhancers combined with a sucrose carrier. The edible substrate enhancers used were HPMC (Dow Chemical Corp, Midland Mich.), modified food starch, maltodextrin (Grain Processing Corp, Muscatine, Iowa), gum arabic (Alfred Wolff, Germany), tapioca dextrin (Grain Processing Corp, Muscatine, Iowa), silicon dioxide (Degussa, Parsippany, N.J.) and xanthan gum (CP Kelco, San Diego Calif.). The edible substrate enhancers were individually added to separate batches of sucrose and mixed by shaking for 2 minutes or blending in a blender for 30 seconds. Some mixtures comprised only one edible substrate enhancer, others included more than one edible substrate enhancer as set forth below. A marshmallow product was heated, whipped by mixing using a Hobart mixer, and cooked. The sugar and edible substrate enhancer mixtures were poured over the top of the soft, warm marshmallows to evenly coat the surface. Excess mixture was brushed, blown or shaken off. The warm, coated marshmallows were then printed with an image using a SPECTRA® Merlin ink jet controller with piezo technology, and propylene glycol based inks (inks comprised 90% propylene glycol, 6% glycerine, 4% water, polyglycerol ester surfactant and one or more of the following colorants: FD&C Blue No. 1, FD&C Yellow No. 5, FD&C Yellow No. 6, FD&C Red No. 3, and FD&C Red No. 40).

When sugar comprising no edible substrate enhancer was used to coat the warm marshmallows, the printed image appeared blurred and fuzzy compared to the images printed onto substrates specially treated with the compositions detailed below. Table 1 shows a summary of the edible substrate enhancers that were used, their amounts (the percentage values are based on weight to weight), and the image quality after printing.

TABLE 1
Image Quality of Images Printed onto Warm Marshmallows Topically
Treated with Sucrose and an Edible Substrate Enhancer.

| | | % Modified | Malto- | Gum | Tapioca | Silicon | Xanthan | Image |
|---|---|---|---|---|---|---|---|---|
| % Sucrose | % HPMC E15 | Food Starch | dextrin | Arabic | Dextrin | Dioxide | Gum | Quality |
| 99 | 1 | | | | | | | Excellent |
| 99 | | 1 | | | | | | Very good |
| 99 | | | 1 | | | | | Very good |
| 99 | | | | 1 | | | | Good |
| 99 | | | | | 1 | | | Fair |
| 99 | | | | | | 1 | | Excellent |
| 99 | | | | | | | 1 | Fair |
| 98 | 1 | | 1 | | | | | Good |
| 97.5 | 1 | | 1 | | | 0.5 | | Very Good |
| 97 | 3 | | | | | | | Excellent |
| 97 | | | 3 | | | | | Very Good |
| 97 | | | | | | 3 | | Poor |
| 97 | | | | | | | 3 | Poor |
| 97 | 1.5 | | | | | 1.5 | | Fair |
| 97 | | | 1.5 | | | 1.5 | | Fair |
| 97 | | | | | | 1.5 | 1.5 | Poor |
| 95.5 | 2 | | 2 | | | 0.5 | | Excellent |

### EXAMPLE 2

### Treatment of Pet Treats with Edible Substrate Enhancers

Dog biscuits were prepared by an extrusion process. A composition was produced by mixing 97% wheat flour (commercially available from King Arthur Flour Company, Vermont) and 3% HPMC. The composition was sieved onto the surface of warmed dog biscuits. An image was ink jet printed onto the surface of dog biscuits that had been contacted with the edible substrate enhancer using a SPECTRA® Merlin ink jet controller with piezo technology, and propylene glycol based inks (for example, inks comprising 90% propylene glycol, 6% glycerine, 4% water, polyglycerol ester surfactant and one or more of the following colorants: FD&C Blue No. 1, FD&C Yellow No. 5, FD&C Yellow No. 6, FD&C Red No. 3, and FD&C Red No. 40). The temperature of the dog biscuits when the images were printed was about 30° C. to 40° C. The image showed a reduction in bleeding and wicking on the pet treats treated with the edible substrate enhancer compared with the same dog biscuits not treated with the edible substrate enhancer and printed at the same temperature.

### EXAMPLE 3 (PROPHETIC)

### Treatment of Edible Substrates with a Variety of Edible Substrate Enhancers and Carriers

Edible substrates such as chewing gum sticks, warm toaster pastries, and warm marshmallows are treated with edible substrate enhancers (HPMC E15, Dow Chemical Corp, Midland Mich.; maltodextrin, Grain Processing Corp, Muscatine, Iowa; silica (synthetic amorphous precipitated silica, CAS No. 112926-00-8, 7.5 microns when sieved), Degussa, Parsippany, N.J.; or xanthan gum, CP Kelco, San Diego Calif.) combined with a sucrose (Imperial Sugar, Sugarland Tex.) or sodium chloride carrier, as set forth in Table 2. The edible substrate enhancers are combined with the carrier, for example by mixing or shaking, and poured or sifted over the surface of the edible substrate. The edible substrate is then printed with an image using a SPECTRA® Merlin ink jet controller with piezo technology, and propylene glycol based inks (for example, inks comprising 90% propylene glycol, 6% glycerine, 4% water, polyglycerol ester surfactant and one or more of the following colorants: FD&C Blue No. 1, FD&C Yellow No. 5, FD&C Yellow No. 6, FD&C Red No. 3, and FD&C Red No. 40). When a carrier comprising no edible substrate enhancer is used to coat the edible substrates, the printed images appear blurred and fuzzy compared to the images printed onto substrates specially treated with the compositions detailed below. Table 2 shows a summary of the edible substrate enhancers that are used, their amounts, and the image quality after printing the treated edible substrate.

TABLE 2
Image Quality of Images Printed onto Edible Substrates Topically
Treated with a Carrier and an Edible Substrate Enhancer.

| | % Sodium | | Malto- | | Image |
|---|---|---|---|---|---|
| % Sucrose | Chloride | % HPMC E15 | dextrin | Silica | Quality |
| 93.8 | | 3 | 3 | 0.2 | Very Good |
| | 93.8 | 3 | 3 | 0.2 | Very Good |
| 95 | | 3 | 1.5 | 0.5 | Good |
| | 95 | 3 | 1.5 | 0.5 | Good |
| 97 | | 3 | | | Excellent |

### EXAMPLE 4 (PROPHETIC)

### Treatment of Chewing Gum with Edible Substrate Enhancers

Chewing gum sticks are coated with a composition comprising 98% sucrose and 2% HPMC or a composition comprising 97% mannitol and 3% HPMC. The compositions are produced by stirring the sucrose and HPMC, or mannitol and HPMC, together and dusting each composition onto the surface of different sticks of chewing gum. The compositions are applied to the chewing gum while it is still warm from processing, and an image is ink jet printed onto the surface of the chewing gum that has been contacted with the edible substrate enhancer using a SPECTRA® Merlin ink jet controller with piezo technology, and propylene glycol based inks (for example, inks comprising 90% propylene glycol, 6% glycerine, 4% water, polyglycerol ester surfactant and one or more of the following colorants: FD&C Blue No. 1, FD&C Yellow No. 5, FD&C Yellow No. 6, FD&C Red No. 3, and FD&C Red No. 40). The temperature of the chewing gum when the images are printed is about 40° C. The image shows a reduction in bleeding and wicking on the chewing gum treated with the compositions containing the edible substrate enhancers compared with the same chewing gum not treated with the edible substrate enhancer and printed at the same temperature.

### EXAMPLE 5 (PROPHETIC)

### Treatment of Toaster Pastries with Edible Substrate Enhancers

Toaster pastries are baked in an oven at 175° C., and either frosted with icing or left unfrosted. Frosted toaster pastries are treated by applying HPMC directly without a carrier to the surface of the frosting such that an even coating is formed, either when the toaster pastries are warm, at 40° C. to 50° C., or after the icing is allowed to set by letting the frosted toaster pastry to cool to room temperature (21° C.). In some instances, HPMC is included in the icing at 0.05%, 0.1%, 0.5%, or 1% by wet weight of the icing instead of being dusted onto the surface. Images are printed onto the warm frosted toaster pastries either immediately after the HPMC is used to coat the icing, or at room temperature after the icing has set, using a SPECTRA® Merlin ink jet controller with piezo technology, and propylene glycol based inks (for example, inks comprising 90% propylene glycol, 6% glycerine, 4% water, polyglycerol ester surfactant and one or more of the following colorants: FD&C Blue No. 1, FD&C Yellow No. 5, FD&C Yellow No. 6, FD&C Red No. 3, and FD&C Red No. 40). The images show a reduction in bleeding and wicking on the frosted toaster pastries treated with HPMC compared with the same frosted toaster pastries not treated with HPMC and printed at the same temperature. Excess HPMC is removed by agitation of the printed toaster pastries and is reused to coat new frosted toaster pastries as described above, which are printed as described above. Images printed on frosted toaster pastries coated with the reused HPMC show a reduction in bleeding and wicking compared with the same frosted toaster pastries not treated with HPMC and printed at the same temperature. No difference in image quality between pastries treated with fresh HPMC or reused HPMC is discernable.

Unfrosted toaster pastries are treated with a composition of 95% sucrose and 5% HPMC. The composition is produced by stirring the components together and the toaster pastry is treated by dusting the composition onto the surface of the toaster pastries while the toaster pastry, just after they emerge from the oven. An image is ink jet printed onto the surface of the toaster pastry that has been contacted with the edible substrate enhancer using a SPECTRA® Merlin ink jet controller with piezo technology, and propylene glycol based inks (for example, inks comprising 90% propylene glycol, 6% glycerine, 4% water, polyglycerol ester surfactant and one or more of the following colorants: FD&C Blue No. 1, FD&C Yellow No. 5, FD&C Yellow No. 6, FD&C Red No. 3, and FD&C Red No. 40). The temperature of the toaster pastries when the images are printed is about 40° C. to 50° C. The image shows a reduction in bleeding and wicking on the toaster pastries treated with the edible substrate enhancer compared with the same toaster pastries not treated with the edible substrate enhancer and printed at the same temperature.

### EXAMPLE 6 (PROPHETIC)

### Treatment of Dog Biscuits with Edible Substrate Enhancers

Two compositions are produced by mixing 97% wheat flour and 3% silica (synthetic amorphous precipitated silica) or 96% wheat flour and 2% HPMC and 2% silica (synthetic amorphous precipitated silica). Dog biscuits are treated with either of the two compositions by dusting the compositions onto the surface of the dog biscuits. An image is ink jet printed onto the surface of the dog biscuits that have been contacted with the edible substrate enhancers using a SPECTRA® Merlin ink jet controller with piezo technology, and propylene glycol based inks (for example, inks comprising 90% propylene glycol, 6% glycerine, 4% water, polyglycerol ester surfactant and one or more of the following colorants: FD&C Blue No. 1, FD&C Yellow No. 5, FD&C Yellow No. 6, FD&C Red No. 3, and FD&C Red No. 40). The temperature of the dog biscuits when the images are printed is about 30° C. to 40° C. The images show a reduction in bleeding and wicking on the dog biscuits treated with the edible substrate enhancer compared with the same dog biscuits not treated with the edible substrate enhancer and printed at the same temperature.

While the present invention has now been described and exemplified with some specificity, those skilled in the art will appreciate the various modifications, including variations, additions, and omissions that may be made in what has been described. Accordingly, it is intended that these modifications also be encompassed by the present invention and that the scope of the present invention be limited solely by the broadest interpretation that lawfully can be accorded the appended claims.

All patents, publications and references cited herein are hereby fully incorporated by reference. In case of conflict between the present disclosure and incorporated patents, publications and references, the present disclosure should control.

What is claimed is:

1. An edible substrate comprising:
a surface, at least a portion of which is coated with an effective amount of a plurality of edible substrate enhancer granules comprising at least one of cellulose derivatives, silicas, dextrins, and combinations thereof; and
an image printed on at least a portion of the surface coated with the edible substrate enhancer surface,
the effective amount of the edible substrate enhancer being an amount that reduces moisture at the surface and improves the quality of the image printed on the portion of the surface.

2. The edible substrate of claim 1, wherein the edible substrate enhancer comprises at least one of hydroxypropylmethylcellulose, maltodextrin, and a combination thereof.

3. The edible substrate of claim 1, wherein the edible substrate enhancer covers from about 0.05% to about 5% of the surface.

4. The edible substrate of claim 1, wherein the edible substrate enhancer covers from about 0.05% to about 5% of the surface corresponding to where the image is printed.

5. The edible substrate of claim 1, wherein the edible substrate comprises a marshmallow-based treat.

6. The edible substrate of claim 1, wherein the edible substrate comprises at least one of chewing gum, a toaster pastry, a waffle, a pet treat and a combination thereof.

7. The edible substrate of claim 1, wherein the effective amount reduces bleeding of the image printed on the substrate by at least about 5 microns.

8. The edible substrate of claim 1, wherein the image comprises at least one of glycerine, shellac and a combination thereof.

9. The edible substrate of claim 1, further comprising a carrier for the edible substrate enhancer, the carrier comprising at least one of sugar, starch, flour, salt, dextran and a combination thereof.

10. The edible substrate of claim 9, wherein the carrier comprises at least one of sucrose, glucose, sodium chloride and a combination thereof.

11. A method of printing an image onto an edible substrate having a surface, comprising:
(a) treating at least a portion of the surface of the edible substrate with an effective amount of a composition comprising an edible substrate enhancer and less than about 10% water by weight; and
(b) printing the image on the treated surface,
the effective amount being an amount that improves the quality of the image printed on the surface.

12. The method of claim 11, wherein the composition of step (a) comprises less than about 5% by weight water.

13. The method of claim 11, wherein the composition of step (a) comprises less than about 1% by weight water.

14. The method of claim 11, wherein the edible substrate enhancer comprises at least one of a cellulose derivative, a silica, a dextrin, a gum, a modified food starch, and a combination thereof.

15. The method of claim 14, wherein the cellulose derivative is HPMC, the dextrin is maltodextrin, and the gum comprises at least one of gum arabic, xanthan gum and a combination thereof.

16. The method of claim 14, wherein the edible substrate comprises at least one of chewing gum, a toaster pastry, a waffle, a pet treat and a combination thereof.

17. The method of claim 11, wherein the edible substrate has an average temperature of at least about 30° C. in step (b).

18. The method of claim 17, wherein the edible substrate has an average temperature of at least about 40° C. in step (b).

19. The method of claim 11, wherein the edible substrate has a temperature higher than a second temperature surrounding the edible substrate in step (b).

20. The method of claim 11, wherein after step (a) the edible substrate enhancer covers from about 0.05% to about 5% of the surface.

21. The method of claim 11, wherein printing the image in step (b) comprises inkjet printing a colored fluid onto the surface.

22. The method of claim 21, wherein the inkjet printing is carried out using a piezo inkjet printer.

23. The method of claim 21, wherein the colored fluid comprises one or more food grade substances.

24. The method of claim 23, wherein the colored fluid comprises a component selected from at least about 1% glycerine, at least about 10% propylene glycol, at least about 5% alcohol, less than about 15% water, at least about 1% shellac or combinations thereof.

25. The method of claim 11, wherein the composition further comprises a carrier comprising at least one of sugar, starch, flour, salt, dextran and a combination.

26. The method of claim 25, wherein the ratio of carrier to edible substrate enhancer is at least about 0.2:1 and less than about 99:1.

27. The method of claim 11, wherein the effective amount reduces bleeding of the image printed on the substrate by at least about 5 microns.

28. A method for ink jet printing an image onto an edible substrate having a surface, the method comprising:
(a) treating at least a portion of the surface of the edible substrate with an effective amount of a composition comprising an edible substrate enhancer comprising at least one of a cellulose derivative, a silica, a dextrin, and a combination thereof and less than about 5% water by weight; and
(b) ink jet printing the image on the treated surface,
the effective amount being an amount that improves the quality of the image printed on the surface.

29. The method of claim 28, wherein the edible substrate enhancer comprises a cellulose derivative and the cellulose derivative comprises hydroxypropylmethylcellulose.

30. The method of claim 28, wherein the edible substrate comprises at least one of a marshmallow, chewing gum, a waffle, pet food and a combination thereof.
